(19) United States
(12) Patent Application Publication
(10) Pub. No.: US 2023/0153623 A1
(43) Pub. Date: May 18, 2023

(54) ADAPTIVELY PRUNING NEURAL NETWORK SYSTEMS

(71) Applicant: GM Global Technology Operations LLC, Detroit, MI (US)

(72) Inventors: Jacob Alan Bond, Rochester Hills, MI (US); Yasaman Esfandiari, Ames, IA (US)

(21) Appl. No.: 17/529,815

(22) Filed: Nov. 18, 2021

(51) Int. Cl. G06N 3/08

(52) U.S. Cl. CPC G06N 3/082

(57) ABSTRACT

A system can include a computer including a processor and a memory. The memory includes a trained neural network with instructions such that the processor is programmed to receive a pruning ratio and prune at least one node of the trained deep neural network based on a pruning ratio.

### INTRODUCTION

The present disclosure relates to neural networks, and more particularly to adaptively pruning a trained neural network.

Vehicles use sensors to collect data while operating, the sensors including radar, LIDAR, vision systems, infrared systems, and ultrasonic transducers. Vehicles can actuate the sensors to collect data while traveling along roadways. Based on the data, it is possible to determine parameters associated with the vehicle. For example, sensor data can be indicative of objects relative to the vehicle.

### SUMMARY

A system can include a computer including a processor and a memory. The memory includes a trained neural network with instructions such that the processor is programmed to receive a pruning ratio and prune at least one node of the trained deep neural network based on a pruning ratio.

In other features, the processor is further programmed to actuate a vehicle component based on output generated by the trained deep neural network.

In other features, the processor is further programmed to select the at least one node for pruning based on a pruning threshold value.

In other features, the processor is further programmed to compare an output of an activation function of the at least one node to the pruning threshold value and select the at least one node for pruning when the activation function is less than the pruning threshold value.

In other features, the processor is further programmed to compare a derivative with respect to a weighted input of the at least one node to the pruning threshold value and select the at least one node for pruning when the derivative with respect to the weighted input is less than the pruning threshold value.

In other features, the processor is further programmed to receive the sensor data from a vehicle sensor of a vehicle and provide the sensor data to the trained deep neural network.

In other features, the processor is further programmed to periodically adjust which nodes in the neural network have been pruned.

In other features, the processor is further programmed to actuate an autonomous vehicle component based on sensor data received at a vehicle sensor.

A system includes a server and a vehicle including a vehicle system. The vehicle system includes a computer including a processor and a memory, the memory including a trained neural network along with instructions such that the processor is programmed to receive a pruning ratio and prune at least one node of the trained deep neural network based on the pruning ratio.

In other features, the processor is further programmed to actuate a vehicle component based on output generated by the trained deep neural network.

In other features, the processor is further programmed to select the at least one node for pruning based on a pruning threshold value.

In other features, the processor is further programmed to compare an output of an activation function of the at least one node to the pruning threshold value and select the at least one node for pruning when the activation function is less than the pruning threshold value.

In other features, the processor is further programmed to compare a derivative with respect to a weighted input of the at least one node to the pruning threshold value and select the at least one node for pruning when the derivative with respect to the weighted input is less than the pruning threshold value.

In other features, the processor is further programmed to receive the sensor data from a vehicle sensor of a vehicle and provide the sensor data to the trained deep neural network.

In other features, the processor is further programmed to actuate an autonomous vehicle component based on sensor data received at a vehicle sensor.

In other features, the processor is further programmed to periodically adjust which nodes in the neural network have been pruned.

A method comprises pruning, via a processor, at least one node of a trained deep neural network based on a pruning ratio and actuating a vehicle component based on an output generated by the trained deep neural network.

In other features, the method includes selecting the at least one node for pruning based on a pruning threshold value.

In other features, the method includes periodically adjusting which nodes of the neural network have been pruned.

In other features, the method includes comparing an output of an activation function of the at least one node to the pruning threshold value and selecting the at least one node for pruning when the activation function is less than the pruning threshold value.

In other features, comparing the derivative with respect to a weighted input of the at least one node to the pruning threshold value and selecting the at least one node for pruning when the derivative with respect to the weighted input is less than the pruning threshold value.

### BRIEF DESCRIPTION OF THE DRAWINGS

FIG. 1 is a diagram of an example system for adaptively pruning a neural network.

FIG. 2 is a diagram of an example server.

FIGS. 3A through 3C are diagrams of an example deep neural network.

FIGS. 4A through 4C illustrate an example process for training a deep neural network.

FIG. 5 is an example image frame of multiple objects detected by a vehicle sensor and the corresponding object classifications.

FIG. 6 is a flow diagram illustrating an example process for adaptively pruning a trained neural network.

FIG. 7 is a flow diagram illustrating an example process for determining whether to actuate a vehicle based on output from a pruned neural network.

### DETAILED DESCRIPTION

Vehicle sensors can provide information about a vehicle's surrounding environment, and computers can use sensor data detected by the vehicle sensors to classify objects and/or estimate one or more physical parameters pertaining to the surrounding environment. Some vehicle computers may use machine learning techniques to assist in classifying objects and/or estimating physical parameters.

Existing deep learning models can be bulky in size and require expensive computational resources for training and inferencing. Due to the size and expensive computational resources, these models may be inefficient or impractical for deploying within a vehicle. In other words, these models may require hosting on cloud servers or data centers rather than vehicles.

The present disclosure discloses systems and methods for pruning a neural network, such as a deep neural network. A pruned neural network can result in a neural network that is relatively smaller in size, e.g., less storage footprint and less computational cost, and that can also generate accurate results, i.e., predictions, classification, etc. when deployed within a vehicle.

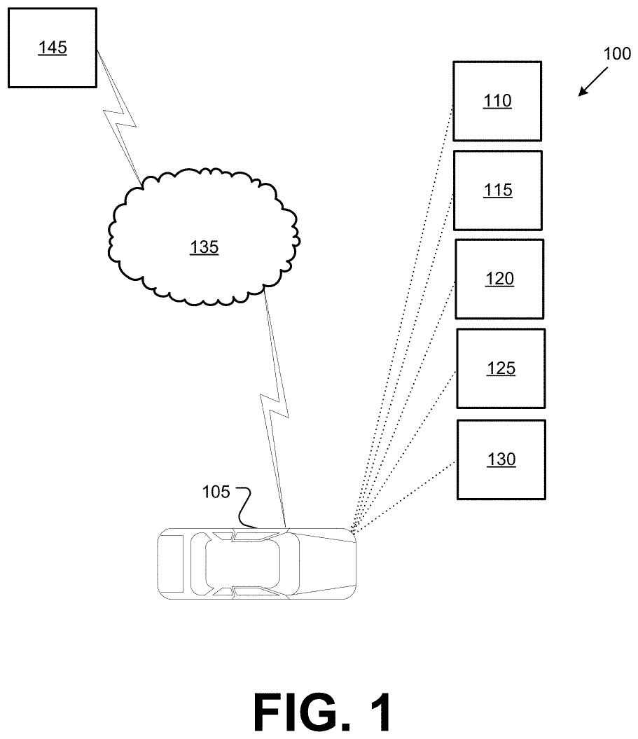

FIG. 1 is a block diagram of an example vehicle control system 100. The system 100 includes a vehicle 105, such as a car, a truck, a boat, an aircraft, etc. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 includes a processor and a memory. The memory includes one or more forms of computer-readable media, and stores instructions executable by the computer 110 for performing various operations, including as disclosed herein.

The computer 110 may operate a vehicle 105 in an autonomous mode, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Positioning System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g., front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle-to-vehicle (V2V) or vehicle-to-infrastructure (V2X) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short range communications (DSRC), and/or wide area networks (WAN), including the Internet, providing data communication services.

The network 135 includes one or more mechanisms by which a computer 110 may communicate with a server 145. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

The server 145 can be a computing device, i.e., including one or more processors and one or more memories, programmed to provide operations such as disclosed herein. Further, the server 145 can be accessed via the network 135, e.g., the Internet or some other wide area network.

A computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

Various techniques such as are known may be used to interpret sensor 115 data. For example, camera and/or lidar image data can be provided to a classifier that comprises programming to utilize one or more image classification techniques. For example, the classifier can use a machine learning technique in which data known to represent various objects, is provided to a machine learning program for training the classifier. Once trained, the classifier can accept as input an image and then provide as output, for each of one or more respective regions of interest in the image, an indication of one or more objects or an indication that no object is present in the respective region of interest. Further, a coordinate system (e.g., polar or cartesian) applied to an area proximate to a vehicle 105 can be applied to specify locations and/or areas (e.g., according to the vehicle 105 coordinate system, translated to global latitude and longitude geo-coordinates, etc.) of objects identified from sensor 115 data. Yet further, a computer 110 could employ various techniques for fusing data from different sensors 115 and/or types of sensors 115, e.g., lidar, radar, and/or optical camera data.

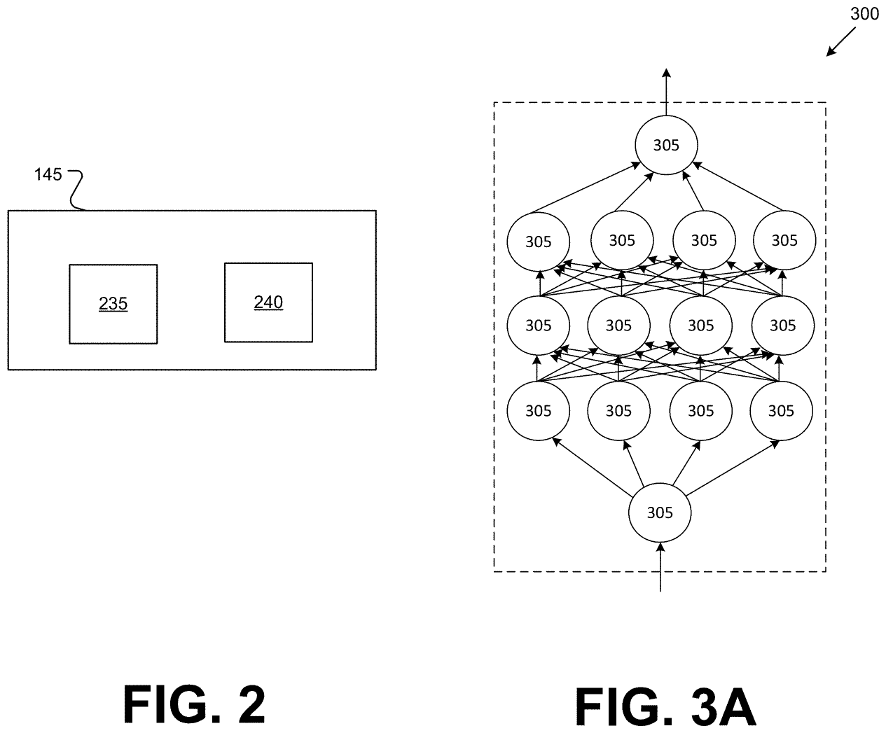

FIG. 2 is a block diagram of an example server 145. The server 145 includes a computer 235 and a communications module 240. The computer 235 includes a processor and a memory. The memory includes one or more forms of computer readable media, and stores instructions executable by the computer 235 for performing various operations, including as disclosed herein. The communications module 240 allows the computer 235 to communicate with other devices, such as the vehicle 105.

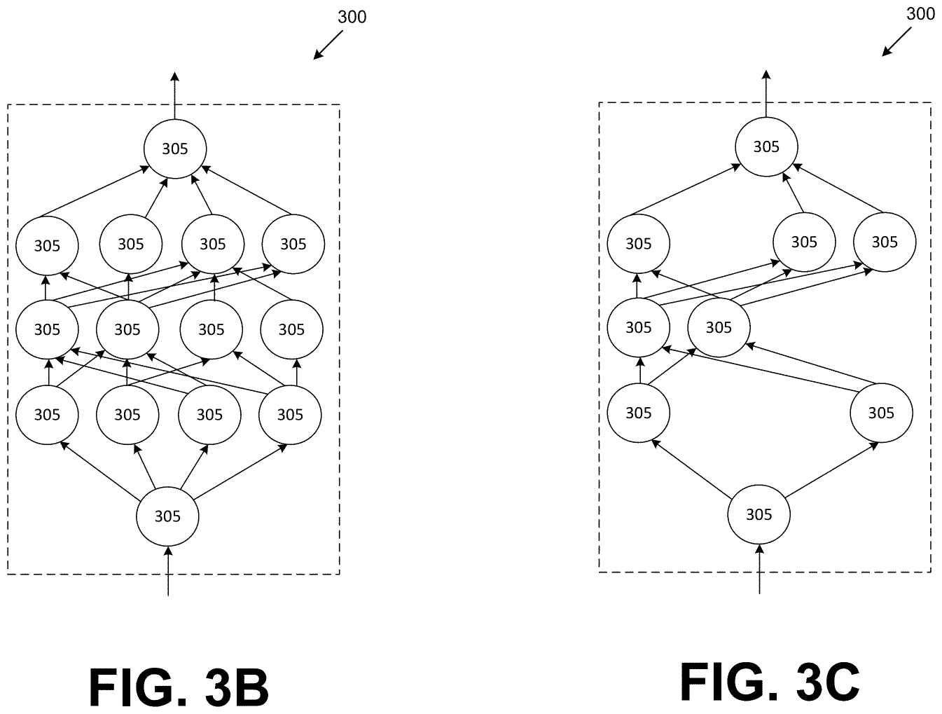

FIGS. 3A through 3C are diagrams of an example deep neural network (DNN) 300. The DNN 300 can be a software program that can be loaded in memory and executed by a processor included in computer 110, for example. In an example implementation, the DNN 300 can include, but is not limited to, a convolutional neural network (CNN), R-CNN (regions with CNN features), Fast R-CNN, and Faster R-CNN. The DNN 300 includes multiple nodes 305, and the nodes 305 are arranged so that the DNN 300 includes an input layer, one or more hidden layers, and an output layer. Each layer of the DNN 300 can include a plurality of nodes 305. While FIGS. 3A through 3C illustrate three (3) hidden layers, it is understood that the DNN 300 can include additional or fewer hidden layers. The input and output layers may also include more than one (1) node 305.

The nodes 305 are sometimes referred to as artificial neurons 305, because they are designed to emulate biological, e.g., human, neurons. A set of inputs (represented by the arrows) to each neuron 305 are each multiplied by respective weights. The weighted inputs can then be summed in an input function to provide, possibly adjusted by a bias, a net input. The net input can then be provided to an activation function, which in turn provides a connected neuron 305 an output. The activation function can be a variety of suitable functions, typically selected based on empirical analysis. As illustrated by the arrows in FIGS. 3A through 3C, neuron 305 outputs can then be provided for inclusion in a set of inputs to one or more neurons 305 in a next layer.

The DNN 300 can be trained to accept sensor 115 data, e.g., from the vehicle 105 CAN bus or other network, as input and generate a distribution of possible outputs based on the input. The DNN 300 can be trained with ground truth data, i.e., data about a real-world condition or state. For example, the DNN 300 can be trained with ground truth data or updated with additional data by a processor of the server 145. The DNN 300 can be transmitted to the vehicle 105 via the network 135. Weights can be initialized by using a Gaussian distribution, for example, and a bias for each node 305 can be set to zero. Training the DNN 300 can include updating weights and biases via suitable techniques such as backpropagation with optimizations. Ground truth data can include, but is not limited to, data specifying objects within an image or data specifying a physical parameter, e.g., angle, speed, distance, or angle of object relative to another object. For example, the ground truth data may be data representing objects and object labels. In another example, the ground truth data may be data representing an object and a relative angle of the object with respect to another object.

After a training phase, the DNN 300 may be pruned to further compress the DNN 300 used during inference. FIG. 3A illustrates an example DNN 300 after training and prior to pruning. FIG. 3B illustrates an example DNN 300 in which various weighted inputs are pruned prior to operation of the DNN 300. FIG. 3C illustrates an example DNN 300 in which various nodes 305 are pruned. Pruning a weighted input and/or a node 305 may comprise deactivating the selected weighted input and/or the selected node 305.

In some implementations, the DNN 300 may be pruned according to a target pruning ratio. The target pruning ratio may be fixed or dynamic. For example, the computer 110 and/or the server 145 may receive an input representing the target pruning ratio. The computer 110 and/or the server 145 may iteratively prune the DNN 300 according to the target pruning ratio. For instance, the computer 110 and/or the server 145 can prune one or more weighted inputs and/or nodes 305 during a first iteration, compare a current pruning ratio of the DNN 300 to the target pruning ratio, and prune one or more weighted inputs and/or nodes 305 during a second iteration when the current pruning ratio of the DNN 300 is less than the target pruning ratio. Once pruned, the computer 110 may implement that pruned DNN 300 for one or more tasks, such as object detection and/or object classification.

The computer 110 and/or the computer 245 can select weighted inputs and/or nodes 305 to prune by comparing a value of the weight of the weighted input or the value of the node 305 to a pruning threshold value or based on the gradient of the loss function with respect to the weight. The pruning threshold value can be selected based on empirical analysis. For example, once deployed to the vehicle 105, the computer 110 can monitor one or more neurons of the DNN 300 during inference.

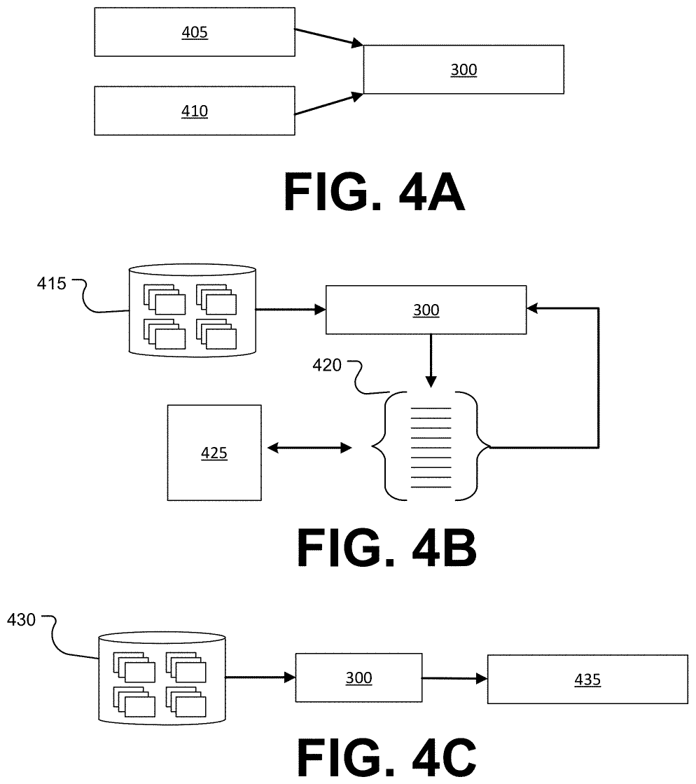

FIGS. 4A and 4B illustrate an example process for training one or more DNNs 300 in accordance with one or more implementations of the present disclosure. FIG. 4A illustrates an initial training phase in which the DNN 300 receives a set of labeled training data, e.g., in the form of training data 405 and training labels 410. The training data 405 may include images that depict various objects of interest within a vehicle environment. The training labels 410 may comprise labels identifying the objects. After the initial training phase, at a supervised training phase, a set of N training data 415 are input to the DNN 300. The DNN 300 generates outputs indicative of an object classification for each of the N training data 415. The object classification is a probability indicative of what objects are present within the received training data. In an example implementation, the DNN 300 can generate a probability indicative of whether an object depicted within an image is a person, a vehicle, a sign, or the like.

FIG. 4B illustrates an example of generating output for one training data 415, such as a non-labeled training image, of the N training data 415. Based on the initial training, the DNN 300 outputs a vector representation 420 of the object classification. The vector representation 420 can be defined as a fixed length representation of the probabilities for each of the N training data 415. The vector representation 420 is compared to the ground-truth data 425. The DNN 300 updates network parameters based on the comparison to the ground-truth boxes 425. For example, the network parameters, e.g., weights associated with the neurons, may be updated via backpropagation. The DNN 300 may be trained at the server 145 and provided to the vehicle 105 via the communication network 135. Backpropagation is a technique for propagating a derivative backwards through successive operations in a computation graph. The loss function determines how accurately the DNN 300 has processed the input data 415. The DNN 300 can be executed a plurality of times on a single input 415 while varying parameters that control the processing of the DNN 300, i.e., until the DNN 300 converges. Parameters that correspond to correct answers as confirmed by a loss function that compares the outputs to the ground truth are saved as candidate parameters. Following the training runs, the candidate parameters that produce the most correct results are saved as the parameters that can be used to program the DNN 300 during operation.

After training, the DNN 300 may be used by the vehicle computer 110 to detect and/or classify sensor data depicted within received images 430 as shown in FIG. 4C. For instance, the DNN 300 can receive sensor data 430 and generate output 435 indicative of an object classification, in one example. The output 435 can be used by the computer 110 to operate the vehicle 105 in some instances. For example, the computer 110 may send control data to one or more actuators 120 to control operation of the vehicle 105 based on the output 435.

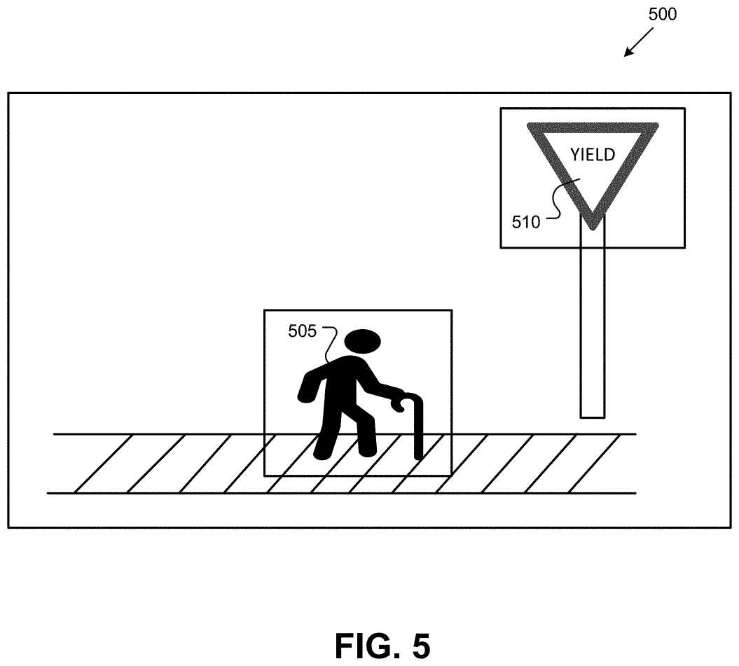

FIG. 5 illustrates an example image 500 captured by the sensors 115. The output generated by the DNN 300 may be object classifications. As shown in FIG. 5, the DNN 300 can classify object 505 as a person and classify object 510 as a sign.

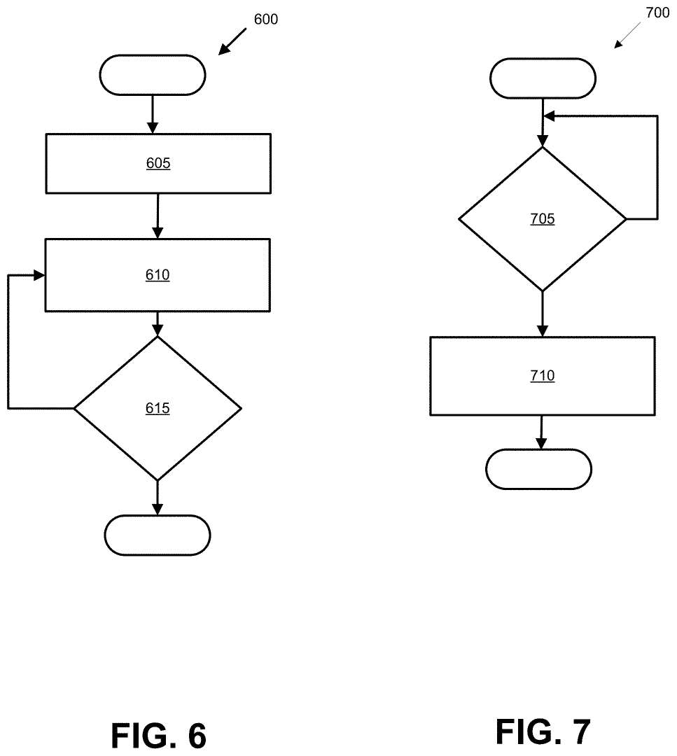

FIG. 6 is a flowchart of an example process 600 for pruning a DNN 300 during inference. Blocks of the process 600 can be executed by the computer 110 of the vehicle 105 and/or the computer 245 of the server 145. The process 600 begins at block 605 in which a trained DNN 300 is received. For example, the DNN 300 can be trained as described above in reference to FIGS. 4A and 4B. As discussed herein, various nodes 305 and/or weighted inputs of the DNN 300 are pruned during inference.

At block 610, weighted inputs and/or nodes 305 are selected for pruning. For example, the computer 110 and/or the computer 245 can determine which nodes 305 comprise the largest activations relative to the pruning threshold value. In this example, the computer 110 and/or the computer 245 may select the nodes 305 having an activation value that is less than the pruning threshold value for pruning. In another example, the computer 110 and/or the computer 245 may compare the values of the weight of the weighted inputs to the pruning threshold value. In this example, if the values of the weight of the weighted inputs is less than the pruning threshold value, the corresponding weighted inputs and/or nodes are selected for pruning. In an example implementation, the selected weighted inputs and/or nodes 305 are deactivated. In some instances, the computer 110 and/or the computer 245 may select one layer of the DNN 300 at a time for pruning purposes. It is understood that the computer 110 and/or the computer 245 may prune the DNN 300 based on sensor data received at the DNN 300 during inference. In an example implementation, the computer 110 and/or the computer 245 may select the nodes 305 and/or weighted inputs after at least one batch of sensor data has been provided to the DNN 300 during inference.

At block 615, a determination is made whether the current pruning ratio of the DNN 300 is less than the target pruning ratio. If the current pruning ratio is less than the target pruning ration, the process 600 returns to block 610. If the current pruning ratio is greater than or equal to the target pruning ratio, the process 600 ends.

FIG. 7 is a flowchart of an example process 700 for controlling the vehicle 105 based on the determined output of a pruned DNN 300. Blocks of the process 700 can be executed by the computer 110. The process 700 begins at block 705, in which the computer 110 determines whether to actuate the vehicle 105 based on the determined output. For example, the computer 110 can receive sensor data from one or more sensors 115. The sensor data is provided to the pruned DNN 300, and the pruned DNN 300 generates outputs based on the sensor data. For example, the DNN 300 may comprise a neural network that is configured to detect and/or identify objects based on the received sensor data. The computer 110 can include a lookup table that establishes a correspondence between a determined output and a vehicle actuation action. For example, based on data received at the pruned DNN 300, the computer 110 may cause the vehicle 105 to perform a specified action, e.g., initiate a vehicle 105 turn, adjust vehicle 105 direction, adjust vehicle 105 speed, etc. In another example, based on the determined distance between the vehicle 105 and an object, the computer 110 may cause the vehicle 105 to perform a specified action, e.g., initiate a vehicle 105 turn, initiate an external alert, adjust vehicle 105 speed, etc.

If the computer determines that no actuation is to occur, the process 700 returns to block 705. Otherwise, at block 710, the computer 110 causes the vehicle 105 to actuate according to the specified action. For example, the computer 110 transmits the appropriate control signals to the corresponding vehicle 105 actuators 120. The process 700 then ends.

In general, the computing systems and/or devices described may employ any of a number of computer operating systems, including, but by no means limited to, versions and/or varieties of the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including a trained neural network with instructions such that the processor is programmed to:
receive a pruning ratio; and
prune at least one node of the trained deep neural network based on a pruning ratio.

2. The system of claim 1, wherein the processor is further programmed to:
actuate a vehicle component based on output generated by the trained deep neural network.

3. The system of claim 1, wherein the processor is further programmed to:
select the at least one node for pruning based on a pruning threshold value.

4. The system of claim 3, wherein the processor is further programmed to:
compare an output of an activation function of the at least one node to the pruning threshold value; and
select the at least one node for pruning when the activation function is less than the pruning threshold value.

5. The system of claim 3, wherein the processor is further programmed to:
compare a derivative with respect to a weighted input of the at least one node to the pruning threshold value; and
select the at least one node for pruning when the derivative with respect to the weighted input is less than the pruning threshold value.

6. The system of claim 1, wherein the processor is further programmed to:
receive the sensor data from a vehicle sensor of a vehicle; and
provide the sensor data to the trained deep neural network.

7. The system of claim 1, wherein the processor is further programmed to: periodically adjust which nodes in the neural network have been pruned.

8. The system of claim 1, wherein the processor is further programmed to:
actuate an autonomous vehicle component based on sensor data received at a vehicle sensor.

9. A system comprising:
a vehicle including a vehicle system, the vehicle system comprising a computer including a processor and a memory, the memory including a trained neural network along with instructions such that the processor is programmed to:
receive a pruning ratio; and
prune at least one node of the trained deep neural network based on the pruning ratio.

10. The system of claim 9, wherein the processor is further programmed to:
actuate a vehicle component based on output generated by the trained deep neural network.

11. The system of claim 9, wherein the processor is further programmed to:
select the at least one node for pruning based on a pruning threshold value.

12. The system of claim 11, wherein the processor is further programmed to:
compare an output of an activation function of the at least one node to the pruning threshold value; and
select the at least one node for pruning when the activation function is less than the pruning threshold value.

13. The system of claim 11, wherein the processor is further programmed to:
compare a derivative with respect to a weighted input of the at least one node to the pruning threshold value; and
select the at least one node for pruning when the derivative with respect to the weighted input is less than the pruning threshold value.

14. The system of claim 9, wherein the processor is further programmed to:
receive the sensor data from a vehicle sensor of a vehicle; and
provide the sensor data to the trained deep neural network.

15. The system of claim 9, wherein the processor is further programmed to:
periodically adjust which nodes in the neural network have been pruned.

16. A method, comprising:
pruning, via a processor, at least one node of a trained deep neural network based on a pruning ratio; and
actuating a vehicle component based on an output generated by the trained deep neural network.

17. The method of claim 16, the method further comprising:
selecting the at least one node for pruning based on a pruning threshold value.

18. The method of claim 16, the method further comprising:
periodically adjusting which nodes of the neural network have been pruned.

19. The method of claim 16, the method further comprising:
comparing an output of an activation function of the at least one node to the pruning threshold value; and
selecting the at least one node for pruning when the activation function is less than the pruning threshold value.

20. The method of claim 16, the method further comprising:
comparing the derivative with respect to a weighted input of the at least one node to the pruning threshold value; and
selecting the at least one node for pruning when the derivative with respect to the weighted input is less than the pruning threshold value.
